(19) United States
(12) Patent Application Publication
(10) Pub. No.: US 2020/0202461 A1
(43) Pub. Date: Jun. 25, 2020

(54) System and Methods of Displaying Customer-Specific Digital Menu Boards

(71) Applicant: Lexmark International, Inc., Lexington, KY (US)

(72) Inventor: Robert Henry Muyskens, Lexington, KY (US)

(21) Appl. No.: 16/227,922

(22) Filed: Dec. 20, 2018

(51) Int. Cl. G06Q 50/12; G06K 19/06; G06K 19/07; G06F 16/27; H04W 4/20; G06K 9/00; G06K 9/62

(52) U.S. Cl. CPC G06Q 50/12; G06K 19/06028; G06K 19/0723; G06F 16/27; G06K 2209/15; G06K 9/00771; G06K 9/00288; G06K 9/6292; H04W 4/20

(57) ABSTRACT

A system and method of displaying a customizable content board at a drive-thru establishment that includes receiving an image captured by an image capture device when a vehicle enters a capture radius of the image capture device; determining at least one identifier from the captured image; and determining whether a database contains a customer data associated with the at least one identifier, the database including data associated with one or more customers of the establishment. Upon the determination that the database contains the customer data associated with the at least one identifier, the example method may determine a customer-specific content based upon the customer data associated with the at least one identifier and transmit the customer-specific content for display on the customizable content board.

### CROSS REFERENCES TO RELATED APPLICATIONS

This patent application is related to U.S. patent application Ser. No. ______, filed contemporaneously herewith, entitled “SYSTEM AND METHODS OF DISPLAYING CUSTOMER-SPECIFIC DIGITAL MENU BOARDS”, which is assigned to the assignee of the present application.

### STATEMENT REGARDING FEDERALLY SPONSORED RESEARCH OR DEVELOPMENT

None.

### REFERENCE TO SEQUENTIAL LISTING, ETC

None.

### BACKGROUND

### 1. Technical Field

The present invention relates generally to a system and methods of displaying digital menu boards for use in a business establishment, such as a drive-thru restaurant. Specifically, the present invention refers to a system and methods for dynamically generating customer-specific content for display on digital display boards, such as digital menu boards.

### 2. Description of the Related Art

Restaurants providing a drive-thru service typically employ one or more free-standing signs for displaying menu items, which are also referred to as menu boards. Typically, menu boards have a menu content printed or painted on a large flat board. However, with the invention of LCD and plasma displays, menu boards have moved from a static printed model to one which can change dynamically, i.e., digital menu boards.

As restaurant operators adapt to changing times, many are turning to digital menu boards as a way to display and promote their offerings. By using digital menu boards, restaurant operators are now able to incorporate full-motion videos, moving images and/or animated effects into their menu display; update menu content, such as pricing and item availability, as frequently as needed for a single location or multiple locations; or promote specific menu items. Typically, menu boards show generic, non-customer specific content. However, because customers have different tastes, nutritional preferences, dietary restrictions and buying histories, it would be beneficial to the restaurant operator and customers if the digital menu board content can be dynamically rendered for specific customer preferences and needs. Such a customer-specific menu board may be more appealing to the customer which may result in optimizing the ordering process and increasing sales for the restaurant operator.

### SUMMARY

A system and methods of displaying a customizable content board at an establishment are disclosed. One example method for displaying a customizable content board includes receiving an image captured by an image capture device when a vehicle enters a capture radius of the image capture device; determining at least one identifier from the captured image; and determining whether a database contains a customer data associated with the at least one identifier, the database including data associated with one or more customers of the establishment. Upon the determination that the database contains the customer data associated with the at least one identifier, the example method may determine a customer-specific content based upon the customer data associated with the at least one identifier; and transmit the customer-specific content for display on the customizable content board.

From the foregoing disclosure and the following detailed description of various example embodiments, it will be apparent to those skilled in the art that the present disclosure provides a significant advance in the art of displaying customizable content. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows a perspective view of a drive-thru establishment utilizing one example embodiment of a digital menu board according to the present disclosure.

FIG. 2 shows one example embodiment of a digital menu board for the drive-thru establishment of FIG. 1.

FIG. 3 shows one example embodiment of a system for displaying customer-specific content through a dynamic display area of the digital menu board of FIG. 2.

FIG. 4 is a flowchart of one example method for displaying customer-specific content to a customer.

FIG. 5 is a flowchart of another example method for displaying customer-specific content.

### DETAILED DESCRIPTION OF THE DRAWINGS

It is to be understood that the disclosure is not limited to the details of construction and the arrangement of components set forth in the following description or illustrated in the drawings. This disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored on the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and/or program instruction means for performing the specified functions. It will also be understood that each block of the diagrams, and combinations of blocks in the diagrams, can be implemented by special purpose hardware-based computer systems that perform the specified functions or steps or combinations of special purpose hardware and computer instructions.

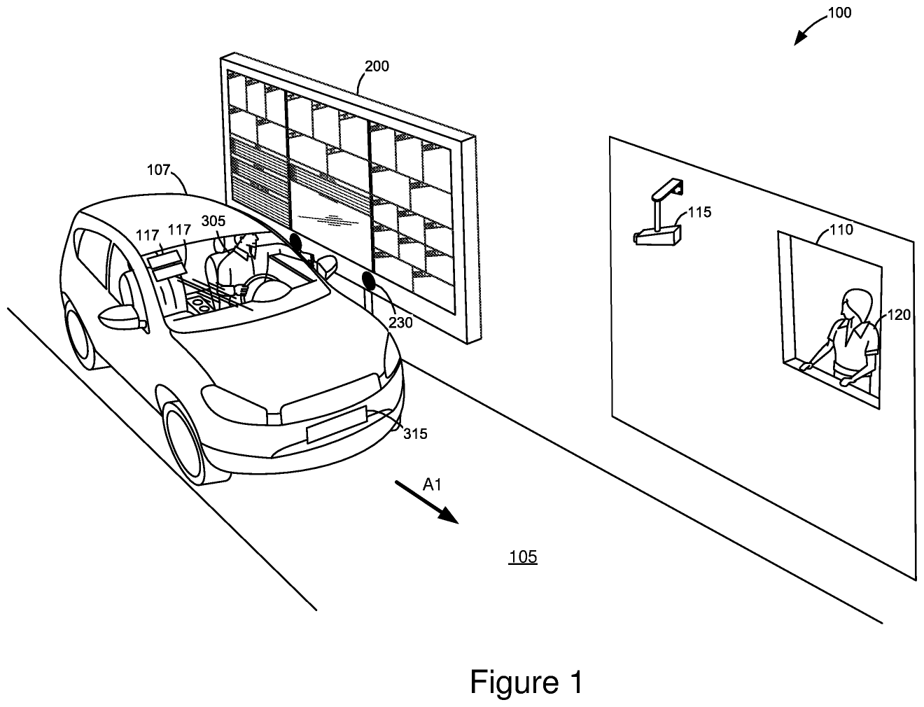

FIG. 1 shows a perspective view of a drive-thru establishment 100 utilizing one example embodiment of a digital menu board 200 according to the present disclosure. For purposes of example only, drive-thru establishment 100 may be a fast-food or restaurant drive-thru restaurant. However, it should be understood that as hereinafter described, drive-thru establishment 100 may be other types of business establishments, such as banks, convenience stores or other businesses having a drive-thru or walk-up service.

Drive-thru establishment 100 has a drive-thru path or lane 105, through which a customer 305 may drive his or her car or other motor vehicle 107 to place and obtain his or her order. Drive-thru lane 105 may be located adjacent to a building of drive-thru establishment 100. At a location along drive-thru establishment 100, an attendant station or window 110 is provided where various items ordered or purchased by the customer may be delivered directly to the customer while he or she remains inside vehicle 107. In some example embodiments, an image capture device 115, such as a video camera, may be mounted alongside attendant station 110 and selectively positioned to observe and capture or take an image of customer 305 and/or vehicle 107. In some example aspects, image capture device 115 may be positioned to detect the front section of vehicle 107, a front license plate 315 and/or any bumper stickers 117 present on the windshield of vehicle 107. In yet other example aspects, image capture device 115 may also be positioned to detect a back section of vehicle 107, a rear license plate 325 and/or any bumper stickers 327 present on the back section of vehicle 107.

In order for customer 305 to utilize drive-thru system of drive-thru establishment 100, customer 305 drives vehicle 107 through drive-thru lane 105 in the direction shown by the arrow μl of FIG. 1. At a location remote from the building of drive-thru establishment 100 and located adjacent to drive-thru lane 105 may be a digital menu or content board 200. In some example aspects, digital menu board 200 may be affixed to the building of drive-thru establishment 100.

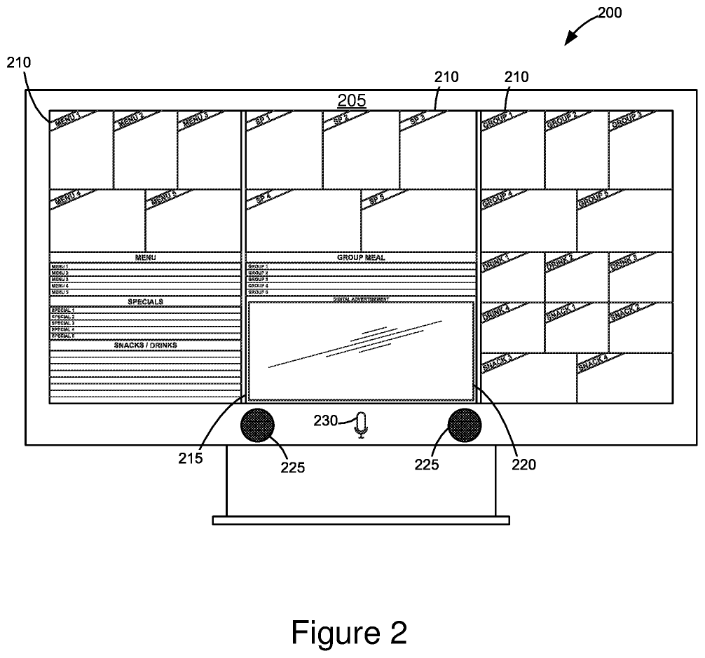

FIG. 2 shows one example embodiment of digital menu board 200 for drive-thru establishment 100 of FIG. 1. As shown in FIG. 2, digital menu board 200 may display a list of the various food items offered by the example fast food restaurant shown in FIG. 1 with their corresponding price, offers, promotions, and/or other restaurant or food item information such as nutritional content. Further, digital menu board 200 may include at least one speaker 225 and a microphone 230 which allows customer 305 to communicate with a restaurant employee of drive-thru establishment 100. In other example embodiments, digital menu board 200 may include a camera (not shown) for capturing images of vehicle 107 and/or customer 305. In operation, customer 305 stops vehicle 107 in drive-thru lane 105 adjacent to digital menu board 200, views the digital menu board 200, and makes selections therefrom.

Referring back to FIG. 1, after customer 305 has decided upon which items he will purchase, customer 305 then communicates his food order to a restaurant employee using speakers 225 and microphone 230. It is to be understood that the restaurant employee may be an attendant 120 at attendant station 110 or another employee such as a cashier operating a point-of-sale (POS) terminal communicating with attendant 120, in a manner as is known in the art. Customer 305 then proceeds to attendant station 110, pays the total amount of the food purchase to attendant 120, and retrieves the purchased food items from attendant 120. In some example embodiments, digital menu board 200 may not include speakers 225 or microphone 230. As a result, after reviewing the content on digital menu board 200, customer 305 may proceed directly to attendant station 110 to directly communicate his food order to attendant 120 at attendant station 110.

After receiving his order, customer 305 proceeds along drive-thru lane 105 and exits the restaurant premises. It will be understood that multiple attendant stations 110 may be present in the drive-thru establishment 100 instead of a single attendant station 110 serving both functions of processing the customer's order and payment and providing the customer's order as shown in FIG. 1. For example, a first attendant station 110 may be used for accepting payment from customer 305, and a second attendant station 110 may be used for delivering or providing the items purchased by customer 305.

In FIG. 2, a front view of the digital menu board 200 is shown for providing images of various food items, menu items, and other conventional advertising and promotional items. In the embodiment shown, digital menu board 200 is divided into at least one static display area 210 and at least one dynamic display area 215. Static display area 210 may display a plurality of static menu, graphic, advertising and/or promotional information. Dynamic display area 215 may be comprised of at least one display device for dynamically displaying visual information such as images, texts, and videos relating to the establishment or its product offerings. In some example aspects, dynamic display area 215 may display a list of items ordered by customer 305. The at least one display device may be, without limitation, a plasma screen, a television, a projection screen, a LCD screen, a cathode ray monitor and/or various combinations thereof. In some alternate example embodiments, digital menu board 200 may be comprised entirely of dynamic display area 215.

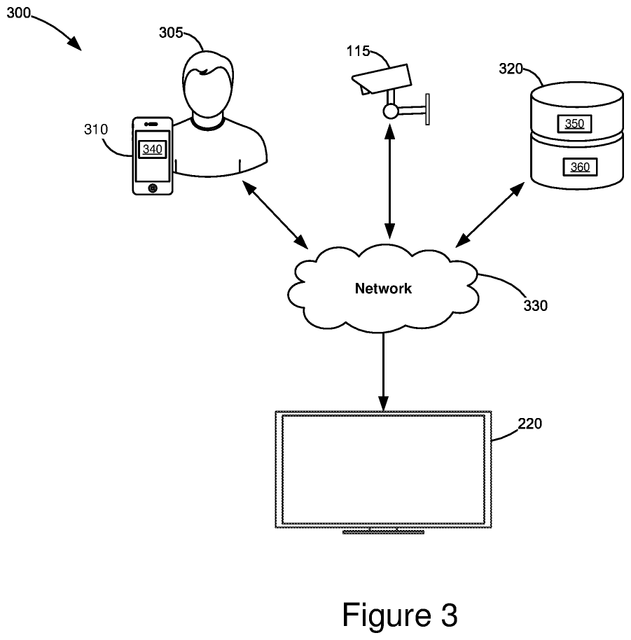

FIG. 3 shows one example embodiment of a system 300 for displaying customer-specific content to customer 305 through dynamic display area 215 of digital menu board 200. System 300 includes a client device 310 of customer 305, image capture device 115, a server 320, and digital menu board 200 communicatively connected to each other through a network 330. Network 330 may be any network capable of allowing communication between two or more computing systems. For example, network 330 may be a communications network or network/communications network system such as, but not limited to, a peer-to-peer network, a hybrid peer-to-peer network, a Local Area Network (LAN), a Wide Area Network (WAN), a public network such as the Internet, a private network, a cellular network, or a combination of different network types. Network 330 may be wireless, wired, and/or a wireless and wired combination network.

Client device 310 may be any computing device such as a personal computer, a laptop computer, a workstation computer, or a mobile computing device having a data storage medium (not shown) for storing executable instructions, a processor for executing instructions, and a wireless communication function for connecting to a network. Client device 310 can scan various Wi-Fi channels or frequencies to detect signals from nearby access points. Client device 310 may be operated by customer 305 and may include a device application 340 that contains customer information regarding customer 305 including general customer preferences and health issues, among others. Device application 340 may also be a business-specific application, such as those offered by retailers, restaurants or other businesses, that may utilized by customer 305 to enhance the customer experience. For example, a business-specific application may contain loyalty award program details, a customer's purchase history, and/or preferences, such favorite items to purchase or customized ordering instructions for customer 305 related to such business. During installation of device application 340 onto client device 310, customer 305 may authorize a customer application 350 in server 320 to retrieve or collect customer data from device application 340.

Image capture device 115 may be any device for recording, capturing, and/or transmitting images. In example system 300, image capture device 115 is represented as a video camera. For example, image capture device 115 may be a closed-circuit television (CCTV) camera, having a direct wired connection with server 320 or an internet protocol (IP) camera connected to the network 330. Image capture device 115 may be equipped with video content analysis (VCA) technology for automatically analyzing captured video to detect and recognize objects or features such as, but not limited to, the face of customer 305, license plate information of vehicle 107, and/or a vehicle make, model and/or color among others not based on a single image. VCA may either be distributed on the image capture device 115 or centralized on dedicated processing systems, such as in server 320. Image capture device 115 may also implement recognition systems known in the art such as facial and automatic vehicle plate number recognition systems for automatically detecting a person or object from a digital image or a video frame from image capture device 115. In other aspects, image capture device 115 may include an instruction to detect or recognize one or more individuals in vehicle 307 as vehicle 307 moves through drive-thru lane 305. In this manner, employees in the business establishment may be made aware of how many people will be placing an order. In still other example aspects, image capture device 115 may further include an instruction to identify an approximate age of the persons in vehicle 307 based upon the one or more individual features (e.g., faces, heights, etc.) or vehicle features (e.g., car seat, booster seat, etc.) recognized in vehicle 307 in determining content to be displayed on digital menu board 200. In yet other aspects and where some or all of the faces recognized by image capture device 115 are known customers (i.e., registered to system 300), the content to be displayed on digital menu board 200 may be a combination of preferences of each recognized customer.

Server 320 may be an application server that contains customer application 350 for receiving, processing and/or storing customer data. Such customer data may include text, images and/or other data received from image capture device 115, such as, for example, license plate information and/or make, model and/or vehicle color information. Customer data may also include personal and/or other information, recorded in connection with a business transaction taking place. For example, customer data may include the order details associated with customer's food order. In some example aspects, customer data may include information received from device application 340 such as, for example, the order history of customer 305 or reward points available to customer 305 if such information is authorized or otherwise made available by customer 305 to customer application 350. In still other example aspects, customer data may include aggregated customer data, such as, for example, order information based upon gender, vehicle make and/or model, vehicle color, the time of day or the day of the week the order is placed, medical conditions (e.g., allergies), etc.

In some alternate example embodiments, customer data may be stored remotely from customer application 350 in a database, such as a customer information database. Such customer information database may also be located on server 320, or it may be located remotely from server 320, provided such customer information database is communicatively coupled to network 330.

In some example embodiments, customer application 350 may automatically retrieve or collect data from device application 340 installed on client device 310 as customer 305 interacts with device application 340 when client device 310 is connected to network 330. In some other example embodiments, customer application 350 may monitor network 330 for a connection of device application 340 to network 330, and if a connection is detected, customer application 350 may add and/or modify existing customer information when it detects changes in customer data.

Customer application 350 may also include instructions or other programming logic to receive customer data received from image capture device 115 and/or device application 340, to process and/or analyze such data to determine the customer-specific content to present to customer 305. Customer application 350 may also include instructions or other programming logic to query or request business content from a content database 360. Customer application 350 may also include instructions or other programming logic to render or display the customer-specific content on digital menu board 200. As used herein, customer-specific content means the business content tailored to customer 305 or a group of customers based upon the received customer data. Customer-specific content may be, but is not limited to, customer-specific pricing or promotions, such as a percentage discount, specific monetary discount, or “Buy 1 meal, get 1 free; menu items based on the dietary and/or specific preferences of customer 305; and/or menu items based on order frequency (i.e., a “favorite”). Customer-specific content may also include adjusting a characteristic of the content displayed, such as the size and/or color of the text and images, based upon a known medical condition of customer 305.

As an example, customer-specific content may be the items purchased most often by customer 305, as evidenced by the order or purchase history of customer 305. As another example, customer-specific content may be the items purchased most often by customers in a particular vehicle make, model and/or color, at a particular time of day, and/or on a particular day of the week. As still another example, customer-specific content may be the items most often purchased by customers meeting a certain criteria. For example, customer-specific content may be based upon a particular characteristic of a group of customers such as, for example, gender or a medical condition.

It will be understood by those skilled in the art that in some example embodiments, the instructions and/or other programming logic for determining customer-specific content may reside in an application separate from, but communicatively coupled to, customer application 350. Such application may also be communicatively coupled to content database 360.

Server 320 may also contain content database 360. Content database 360 contains business specific content, such as product names, prices, availability and/or promotional or other business data, from which the customer-specific content is derived. For example, if drive-thru establishment 100 is a restaurant, content database 360 may include, but is not limited to, the food items available for purchase, their corresponding prices and ingredients, nutritional information and/or promotions offered. Content database 360 transmits the customer-specific content requested by customer application 350 for display on digital menu board 200. Content database may also transmit non-customer-specific business content (i.e., for display on static display area 210 of digital menu board 200).

It will also be understood by those skilled in the art that content database 360 may reside on a separate or different server than server 320 in some example embodiments. In such example embodiments, the server housing content database 360 is communicatively connected to server 320 via network 330. In some example aspects, the server housing content database 360 may also be communicatively connected to display menu board 200 via network 330.

In some alternate example embodiments, content database 360 determines the customer-specific content to be displayed on display menu board 200. In such example embodiments, content database 360 may contain instructions and/or other programmable logic for receiving customer data, processing and/or analyzing such data to determine the most appropriate or customer-specific content to display in dynamic display area 215 of digital menu board 200.

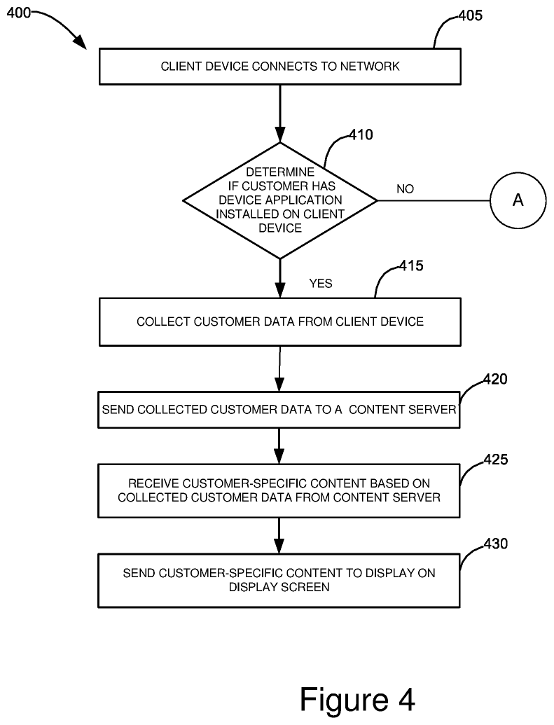

FIG. 4 is a flowchart 400 of one example method for displaying customer-specific content to customer 305. In FIG. 4, the customer-specific content for display on display device 220 may be based on the data collected from customer 305 via client device 310. Data retrieved from client device 310 may be compared to customer data stored in content database 360.

At block 405, a connection between client device 310 and network 330 is made. In some example aspects, client device 310 may connect to network 330 via an access point. Customer 305 may utilize client device 310 to connect to network 330 by using client device 310 in searching for available wireless network connections, selecting network 330, and requesting access to network 330. In other example embodiments, client device 310 may automatically connect to network 330 via a Bluetooth beacon. Bluetooth beacons, as are known in the art, are one-way transmitters to a receiving device, such as client device 310.

In other example embodiments, device application 340 may include at least one instruction to detect whether client device 310 is within a vicinity of drive-thru establishment 110 such that client device 310 does not need to connect to network 330. A Global Positioning System (GPS) position of mobile device 310 may be used, for example, in determining a location of client device 310 relative to drive-thru establishment 100.

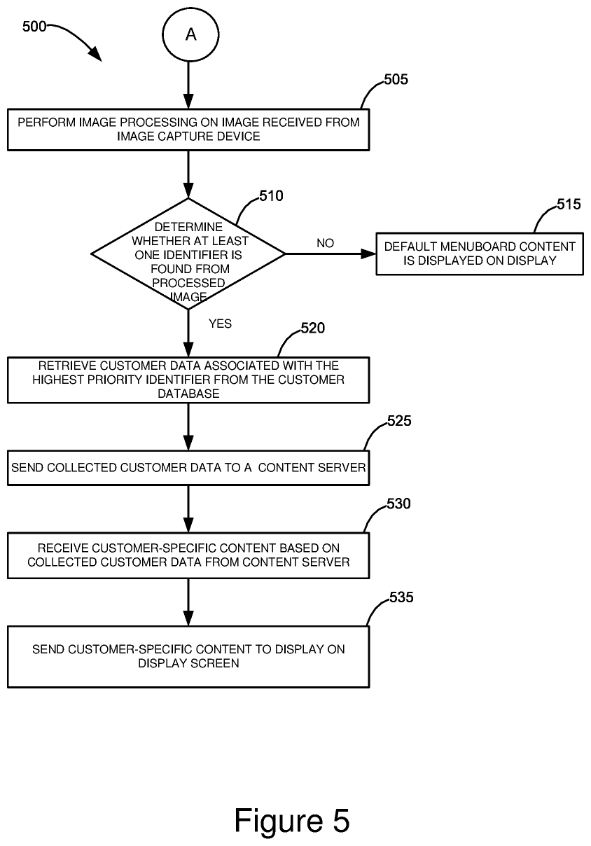

At block 410, after client device 310 establishes connection to network 330, customer application 350 determines whether or not device application 340 has been installed in client device 310. If it is determined that device application 340 is not installed in the client device 310, another method, such as example method 500 in FIG. 5, may be used to obtain customer-specific content.

If, at block 410 it is determined that device application 340 has already been installed on client device 310, customer application 350 retrieves customer data from device application 340 at block 415. Retrieved customer data may be, without limitation, the customer's average bill (e.g., 1 menu focused customer); most frequently ordered breakfast, lunch, and/or dinner meal item; average calorie count of ordered menu items; most frequently ordered drink; most frequently selected side dishes; likelihood of ordering new menu items; average carbohydrate, fat, sugar, and or salt consumption; average mass or volume of items ordered; dietary practices (such as veganism, vegetarianism, and pescetarianism); specific food preferences, such as usual salad dressing choice or spice level; vehicle make, model or color information; and personal information, such as age, gender, race, medical conditions (such as diabetes or eyesight issues), etc. Further, a standard deviation may be applied to retrieve the amount of variation between any of the aforementioned collected customer data and the customer's order history.

In some example embodiments, customer application 350 may include at least one instruction to determine whether device application 340 includes data related to customer 305 following a determination that device application 340 is installed in client device 310 and prior retrieving data from device application 340. Upon a determination that device application 340 does not include any data related to customer 305, customer application 350 may retrieve or collect attributes associated with customer 305 and store these attributes to content database 360 and assign these attributes as identifiers for customer 305.

At block 420, customer application 350 determines the customer-specific content to be displayed on digital menu board 200. In making this determination, customer application 350 first identifies whether or not there is at least one existing entry associated with customer 305 in content database 360 using at least one customer data retrieved from device application 340 at block 415. If it is determined that no existing entries are associated with customer 305, customer 305 is identified as a new customer, and customer application 350 creates at least one new entry in content database 360 based upon the customer data collected from device application 340.

If it is determined that an entry associated with customer 305 already exists in content database 360, customer application 350 may request customer-specific content from content database 360 based upon the information in the entry(ies) associated with customer 305 stored in content database 360. Customer application 350 may also update existing entry(ies) of customer 305 in content database 360 based upon differences in the previously stored information and newly collected customer data.

In some example aspects, customer application 350 may determine the customer-specific content to be displayed on display menu board 200 by applying one or more predictive analytics techniques such as, for example, data mining, machine learning, modeling, and statistics, to the customer data. After determining the customer-specific content to display, customer application 350 may retrieve the customer-specific content from content database 360.

How tailored the customer-specific content is to customer 305 may depend upon the volume of personal information, purchase history, and/or other relevant customer data retrieved or collected from device application 340. The larger the volume of collected customer data, the more tailored the customer-specific content may be. For example, when the collected customer data includes only the make or model of vehicle 107, the displayed customer-specific content may be limited to items most commonly purchased by the aggregated group of customers who drive the same make or model vehicle. In contrast, when the collected customer data includes a relatively large volume of personal information, such as the name and purchase history of customer 305, the customer-specific content displayed may include a personalized greeting, such as “Welcome back, Susie”, and the items most commonly ordered by customer 305.

In other example aspects, other techniques of determining the customer-specific content based on the collected customer data retrieved from client device 310 may be used, as will be known in the art. For example, the customer-specific content may be based on a franchise location of the business establishment, a trend in the customer's average calorie or nutritional content ordered, one or more condiments typically used by customer 305 with their ordered items, the weather and local events in the area as well as holidays or other occasions.

In some other example aspects, customer-specific content may include options for dividing the bill or offering to place separate orders if multiple individuals are detected in the vehicle.

At block 425, the customer-specific content has been determined, customer application 350 may request the customer-specific content from content database 360 and, once received, send or transmit the customer-specific content to digital menu board 200 for display to customer 305. In some alternate example embodiments, customer application 350 may send or transmit instructions directing content database 360 to cause digital menu board 200 to display the customer-specific content.

FIG. 5 is a flowchart of another example method 500 for displaying customer-specific content. Example method 500 may be used when customer 305 does not have device application 340 installed on client device 310. Example method 500 may also be used when no connection to network 330 is available. In yet other example embodiments, example method 500 may also be performed when device application 340 installed in client device 310 does not include any data associated with customer 350.

At block 505, as customer 305 drives along drive-thru lane 105, image capture device 115 may detect vehicle 107 and capture an image of customer 305 and/or vehicle 107. Image capture device 115 may also include image processing technology to identify or focus on a specific aspect or portion of vehicle 107. For example, image capture device 115 may be programmed to detect or identify a license plate, face, the make, model and/or color of vehicle 107. In some example aspects, image capture device 115 may perform such detection or identification prior to capturing the image. In some other example aspects, image capture device 115 may detect, identify and/or extract desired information from a captured image. In some alternate example embodiments, the image processing on the captured image may be performed by customer application 350 instead of by image capture device 115.

Image capture device 115 may then transmit the captured image to customer application 350.

In one example embodiment, customer application 350 may use the captured image or information extracted therefrom as an identifier. As used herein, an identifier is a parameter used in querying or searching content database 360 for an entry associated with customer 305. In some example aspects, when the captured image includes a face image, customer application 350 may use the face image as an identifier and compare the face image to existing customer face image entries in customer application 350 to find or locate a match.

In other example aspects, when the captured image includes an image of vehicle 107, customer application 350 may determine the make or model and use such information as an identifier. In such example aspects, customer application 350 may compare at least a portion of vehicle information make to existing customer entries in content database 360 to find or locate a match. In still other example aspects, customer application 350 may use the license plate information extracted from the captured image of vehicle 107 as an identifier.

In some example aspects, the captured image may include at least one sticker, and customer application 350 may associate each identified sticker with customer 305. A sticker may include a text string, a barcode, and/or graphics. The sticker image may also contain information about customer 305.

In some alternate example embodiments, image capture device 115 may be a radio-frequency identification (RFID) reader or antenna installed near drive-thru lane 105. RFID tags may be affixed to vehicle 107 with an adhesive, such as a sticker. RFID tags may also be adhered to paper or other media and placed in or on car. For example, an RFID tag may be included in a piece of paper placed on the dashboard or in a console or pocket of vehicle 107. The RFID reader or antenna may detect the contents of the RFID tag and transmit customer data or information detected therefrom to customer application 350.

At block 510, customer application 350 determines whether at least one identifier was retrieved from the captured image received at block 505. It will be appreciated that when at least two identifiers are retrieved, a priority system may be used by customer application 350. Each detection method may vary in priority level as preset by the business or establishment, such that the detection method with the highest priority will be processed first. For example, priority order may be set from the most-specific criterion to the most generic criterion, such that when there are three identifiers retrieved (i.e., face, license plate, and vehicle make), the face identifier would have the highest priority and the vehicle make having the lowest priority. An average age of the customers based on the one or more faces detected in vehicle 107 may also be considered as an identifier. Further, it will be also appreciated that such a priority system may also be used when vehicle 107 of customer 305 is detected by image capture device 115 and when customer application 350 detects the presence of device application 340.

At block 515, if no identifier is detected in the processed image, generic or default menu board content may be displayed on display menu board 200. If an identifier is detected in the processed image, customer application 350 determines whether the identifier is associated with an existing entry in content database 360 at block 520. If it is determined that there is no customer data associated with a first identifier, customer application 350 may proceed to determine if another identifier has been detected at block 525. If another identifier has been detected, customer application 350 may repeat the action of attempting to associate the identifier with an entry in content database 360 (block 530). This process of proceeding to a next identifier and determining whether or not there is customer data associated with the next identifier may be repeated until all identifiers have been checked or exhausted or until the checking of additional more identifiers is no longer desired. In some example aspects, the evaluation of all identifiers may be performed in a priority order set by the programmer or administrator of customer application 350. In other example aspects, the priority may be set by the business establishment. If no identifier is associated with an existing entry in content database 360, generic or default menu board content may be displayed on display menu board. 200.

If it is determined that the identifier matched or is otherwise associated with customer data in content database 360, customer application 350 may request from content database 360 customer-specific content based upon the customer data (block 535). In one example embodiment, customer application 350 may retrieve customer-specific content associated with the highest priority identifier. In other example embodiments, customer application 350 may determine the customer-specific content to be displayed on digital menu board 200 using one or more of the predictive analytics or other techniques as discussed above. At block 540, customer application 535 may request from content database 360 the customer-specific content based on the collected customer data, and content database 360 may transmit the customer-specific content for display on digital menu board 200.

In some example embodiments, when no identifier matches an entry in content database 360, system 300 may indicate to attendant 120 that customer 305 is a new customer. attendant 120, through the microphone 230 of digital menu board 200 (see FIG. 2), may then ask customer 305 if he/she would like to share personal information so that customer-specific content may be displayed on digital menu board 200 during future visits. If customer 305 agrees, basic personal information, such as customer name, and together with any identifiers detected may be stored in content database 360. If customer 305 does not agree, system 300 may store any identifier detected by customer application 350 into content database 360 and flag the entry as restricted such that if identifiers matching customer 305 are detected in the future, system 300 would not prompt attendant 120 to ask customer 305 about participation in the future.

In alternative example embodiments, when no identifier matches an entry in content database 360, a link to device application 340 on client device 310 may be displayed on dynamic display area 215 for customer 305 to use in installing device application 340 in client device 310. In another example aspect, a set of instructions as to how to install device application 340 in client device 310 may be displayed on dynamic display area 215 for guiding customer 305 in the installation process.

In another example embodiment, the customer-specific content determined at blocks 420 and 535 may be sent to client device 310 for customer 305 to view in addition to being displayed on digital menu board 200.

In yet other example embodiments not shown, customer application 350 may be communicatively connected to a point of sale or point of purchase system of drive-thru establishment 100 such that purchase information of customer 305 may be automatically updated in customer application 350 after completion of the business transaction.

In still other example embodiments, example methods 400 and 500 may work concurrently to determine even more tailored customer-specific content to display on digital menu board 200.

It will be understood that the example methods and systems described herein are illustrative and should not be considered limiting. It will also be appreciated that the actions described and shown in the example flowcharts may be carried out or performed in any suitable order. It will also be appreciated that not all of the actions described in the example methods need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of displaying a customizable content board at an establishment, comprising:
receiving an image captured by an image capture device when a vehicle enters a capture radius of the image capture device;
determining at least one identifier from the captured image;
determining whether a database contains a customer data associated with the at least one identifier, the database including data associated with one or more customers of the establishment; and
upon the determination that the database contains the customer data associated with the at least one identifier:
determining a customer-specific content based upon the customer data associated with the at least one identifier; and
transmitting the customer-specific content for display on the customizable content board.

1. The method of claim 1, wherein the determining the customer-specific content comprises:
transmitting the retrieved customer data to a content server which includes a list of items offered by the establishment and at least one instruction for determining the customer-specific content from the list of items, and
receiving, from the content server, the customer-specific content.

2. The method of claim 1, wherein the at least one identifier is a license plate information of the vehicle.

3. The method of claim 1, wherein the at least one identifier is a facial image of a customer.

4. The method of claim 1, wherein the at least one identifier is at least one of a barcode, a text string, and a programmed radio-frequency identification tag.

5. The method of claim 1, wherein the at least one identifier is a model of the vehicle.

6. The method of claim 1, further comprising updating the customer data in the database based upon a transaction with the establishment.

7. The method of claim 1, wherein at least one of the receiving the captured image, the determining the at least one identifier and the determining whether the database contains the customer data is performed by a server of the establishment communicatively coupled to the database.

8. A computing device having a non-transitory computer readable storage medium containing one or more instructions to generate a customizable content board, the one or more instructions comprising an instruction to:
receive, from a customer having a client device located in a vicinity of a drive-thru establishment, a request to connect to a network;
connect the client device to the network;
determine whether a device application storing customer data is installed on the client device; and
upon a determination that the device application is installed on the client device:
retrieve the customer data from the client device;
determine a customer-specific content based on the retrieved customer data; and
generate the customer-specific content for display on the customizable content board.

9. The computing device of claim 9, wherein the instruction to retrieve the customer data from the client device is performed while the client device is connected to the network.

10. The computing device of claim 9, wherein the instruction to retrieve the customer data from the client device includes an instruction to retrieve customer information from the device application.

11. The computing device of claim 9, further comprising one or more instructions to:
upon a determination that the customer does not have the device application installed on the client device:
capture an image using an image capture device in communication with a server when a vehicle enters a capture radius of the image capture device;
determine at least one identifier from the captured image;
determine whether a database contains a customer data associated with the at least one identifier; and
upon the determination that database contains the customer data associated with the at least one identifier:
determine a customer-specific content based upon the customer data associated with the at least one identifier; and
transmit the customer-specific content for display on the customizable content board.

12. The computing device of claim 9, wherein the instruction to receive the request to connect to the network is performed automatically when the client device is in the vicinity of the drive-thru establishment.

13. The computing device of claim 9, wherein the instruction to receive the request to connect to the network is performed upon initiation by the customer.

14. The computing device of claim 9, wherein the client device is a mobile device.

15. A computing device having a non-transitory computer readable storage medium containing one or more instructions to generate content for a customizable content board, the one or more instructions comprising an instruction to:
receive an identifier captured from a vehicle within a capture radius of an image capture device;
generate customer-specific content if a customer database contains a data associated with the captured identifier, the customer-specific content based upon the customer data;
generate generic content if the customer database does not contain a customer data associated with the captured identifier; and
transmit one of the generated customer-specific content and the generic content to the customizable content board for display.

16. The computing device of claim 16, wherein the is one of a sticker image, a facial image, a license plate information, and a vehicle model information.

17. The computing device of claim 17, wherein the sticker image is at least one of a barcode, a text string, and a programmed radio-frequency identification tag.

18. The computing device of claim 16, further comprising an instruction to:
store the captured identifier in the customer database if the customer database does not contain the captured identifier;
associate transaction information with the captured identifier; and
store the transaction information in the customer database.

19. The computing device of claim 16, wherein the instruction to generate the customer-specific content comprises an instruction to:
transmit the data associated with captured identifier to a content database;
receive from the content database, the customer-specific content.
